(19) United States
(12) Patent Application Publication
(10) Pub. No.: US 2014/0157050 A1
(43) Pub. Date: Jun. 5, 2014

(54) TEST SYSTEM AND TEST METHOD BY GENERATING VIRTUAL TEST UNIT OUTSIDE DEVICE TO BE TESTED

(71) Applicants: INVENTEC (PUDONG) TECHNOLOGY CORPORATION, Shanghai (CN); INVENTEC CORPORATION, Taipei (TW)

(72) Inventor: Zhi Guang ZHAO, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/794,868

(22) Filed: Mar. 12, 2013

(30) Foreign Application Priority Data
Nov. 30, 2012 (CN) 201210507481.6

(51) Int. Cl. G06F 11/26

(52) U.S. Cl. CPC G06F 11/261
USPC 714/28

(57) ABSTRACT

A test system and a test method by generating a virtual test unit outside a device to be tested are provided, where a virtual test unit is generated outside a device to be tested, and the virtual test unit executes test tools according to a test script, so as to test the device to be tested. Through such a technical means, overall performance of the device to be tested and including multiple entities can be tested, and a technical efficacy of expanding an application scope of an existing test model can be achieved.

### BACKGROUND OF THE INVENTION

1. Field of Invention

The present invention relates to a test system and a test method, and in particular, to a test system and a test method by generating a virtual test unit outside a device to be tested.

2. Related Art

In an era of one device merely having an entity providing one service, each device to be tested is an actual test unit. After the device to be tested is connected, a test system actively transmits a test program to the device to be tested and controls the device to be tested to execute the test program. After the test program is executed, the test system acquires a test script corresponding to the device to be tested, executes test tools one by one according to a sequence of the corresponding test tools scheduled in the test script, and collects a test result produced after the device to be tested is tested with the test tools, so as to test the device to be tested.

As network services develop rapidly, a device having an entity capable of providing multiple services emerges, for example, a rack formed by multiple servers. To support the test of the device having an entity capable of providing multiple services, the test system changes the design of the test script, and enables the test script not to include the scheduled test tools for testing merely one actual test unit, so that the test tools required to be used by all actual test units in the device to be tested are integrally scheduled in the test script. In the test script, test tools of each actual test unit may be scheduled according to a type of the device to be tested and each actual test unit in the device to be tested; meanwhile, different test stages are also defined, so that the actual test units in the device to be tested can be synchronously tested.

Although the device to be tested includes entities independently providing services, the entities still share a system item such as a power system and a cooling system. Therefore, the test performed on each actual test unit is insufficient to fully manifest overall performance of the device to be tested. However, through the test tools executed by the actual test units, it obviously cannot be known whether the entities executing the test tools are included in the device to be tested, so the device to be tested cannot be integrally tested.

To sum up, it can be known that, the prior art has a problem all the time that an existing test model cannot test the overall performance of the device to be tested and including multiple entities. Therefore, it is necessary to provide an improved technical means to solve this problem.

### SUMMARY OF THE INVENTION

In view of the problem in the prior art that the test model cannot test the overall performance of the device to be tested and including multiple entities, the present invention discloses a test system and a test method by generating a virtual test unit outside a device to be tested.

In the present invention, the test system by generating a virtual test unit outside a device to be tested is applied to a test apparatus, where the test system at least includes: a test unit generation module, used to generate a virtual test unit corresponding to the device to be tested; a script acquisition module, used to acquire a test script corresponding to the device to be tested, where the test script at least includes a virtual test list corresponding to the virtual test unit; and a test module, used to execute, in the virtual test unit, a test tool corresponding to the virtual test list, so as to test the device to be tested.

In the present invention, the test method by generating a virtual test unit outside a device to be tested is applied to a test apparatus, where the test method at least includes: connecting the test apparatus with the device to be tested; generating a virtual test unit corresponding to the device to be tested; acquiring a test script corresponding to the device to be tested, where the test script at least includes a virtual test list corresponding to the virtual test unit; and executing, in the virtual test unit, a test tool corresponding to the virtual test list, so as to test the device to be tested.

The system and the method disclosed in the present invention are described above. Different from the prior art, in the present invention, the virtual test unit is generated outside the device to be tested, and the virtual test unit executes the test tool according to the test script, so as to test the device to be tested and solve the problem in the prior art, thereby achieving a technical efficacy of expanding an application scope of the existing test model.

### BRIEF DESCRIPTION OF THE DRAWINGS

The invention will become more fully understood from the detailed description given herein below illustration only, and thus is not limitative of the present invention, and wherein:

FIG. 1 is a system architecture diagram of a test system by generating a virtual test unit outside a device to be tested according to the present invention.

FIG. 2 is a schematic diagram of a test script according to an embodiment of the present invention.

FIG. 3 is a flow chart of a test method by generating a virtual test unit outside a device to be tested according to the present invention.

### DETAILED DESCRIPTION OF THE INVENTION

The present invention will be apparent from the following detailed description, which proceeds with reference to the accompanying drawings, wherein the same references relate to the same elements.

In the present invention, during a test of a device to be tested, a virtual test unit is generated outside the device to be tested, so as to test overall performance of the device to be tested by using the external virtual test unit. The device to be tested in the present invention may be a stand-alone device such as a computer, a cell phone, a Personal Digital Assistant (PDA), a server, or a network apparatus; and the device to be tested may also be a device including multiple entities independently providing services, for example, a rack provided with multiple servers.

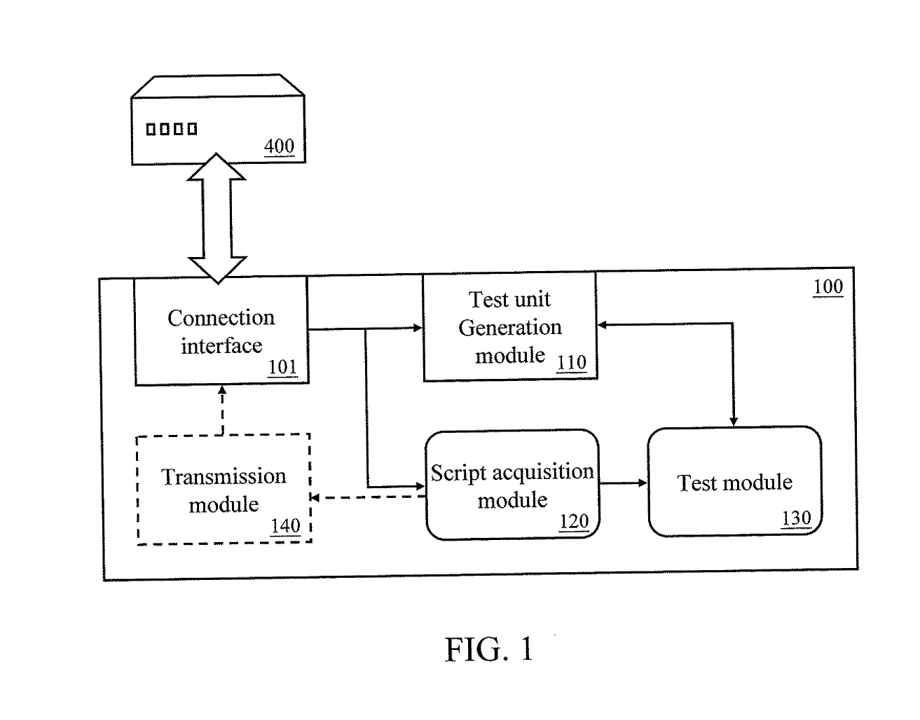

FIG. 1 is a system architecture diagram of a test system by generating a virtual test unit outside a device to be tested according to the present invention. First, with reference to FIG. 1, the system operation of the present invention is described. As shown in FIG. 1, the system of the present invention includes a test unit generating module 110, a script acquisition module 120, a test module 130, and an addable transmission module 140. A test apparatus 100 for executing the present invention further includes a connection interface 101.

The connection interface 101 is used to provide a connection between the device 400 to be tested and the test apparatus 100 for executing the present invention. Generally speaking, the device 400 to be tested is connected to the test apparatus 100 for executing the present invention through an actual line. The device 400 to be tested is the same as that in the prior art, and includes one or more units under test (UUT, hereinafter actual test units).

The test unit generation module 110 is used to, after the device 400 to be tested is connected, through the connection interface 101, to the test apparatus 100 for executing the present invention, generate one or more virtual test units corresponding to the device 400 to be tested. The test unit generation module 110 may start multiple virtual test units in the same execution environment, and each virtual test unit may correspond to different devices 400 to be tested.

The test unit generation module 110 may establish the virtual test units on a specific server (not shown) outside the test apparatus 100 for executing the present invention, and may also execute a virtual machine (VM) in the test apparatus 100 for executing the present invention and establish the virtual test units in the VM. More practically, the execution environment in which the test unit generation module 110 generates the virtual test units is not particularly limited. The test unit generation module 110 may generate the virtual test units at a local end or a remote end of the test apparatus 100, and may also generate the virtual test units on an actual device or a VM.

In the present invention, the virtual test unit is similar to the actual test unit in the device 400 to be tested, and both are test models for testing a specific item in the device 400 to be tested. The different between the two lies in that, the actual test unit exists inside the device 400 to be tested, and may test a specific element, module, or system inside the device 400 to be tested; while the virtual test unit exists outside the device 400 to be tested, and may integrally test the device 400 to be tested.

The script acquisition module 120 is used to acquire a test script corresponding to the device 400 to be tested. The test script acquired by the script acquisition module 120 is similar to that in the prior art, and includes multiple test items scheduled according to identification data of the device 400 to be tested or identification data of entities in the device to be tested, where the test items form multiple groups of test lists, the test items scheduled in the test script are probably divided into multiple test stages, and the test items in the same test stage may be synchronously tested. In addition, the test items scheduled in the test script are probably arranged in a test sequence, so as to define a rule of synchronously testing the entities in the device 400 to be tested. Each test item may be tested by using a corresponding test tool.

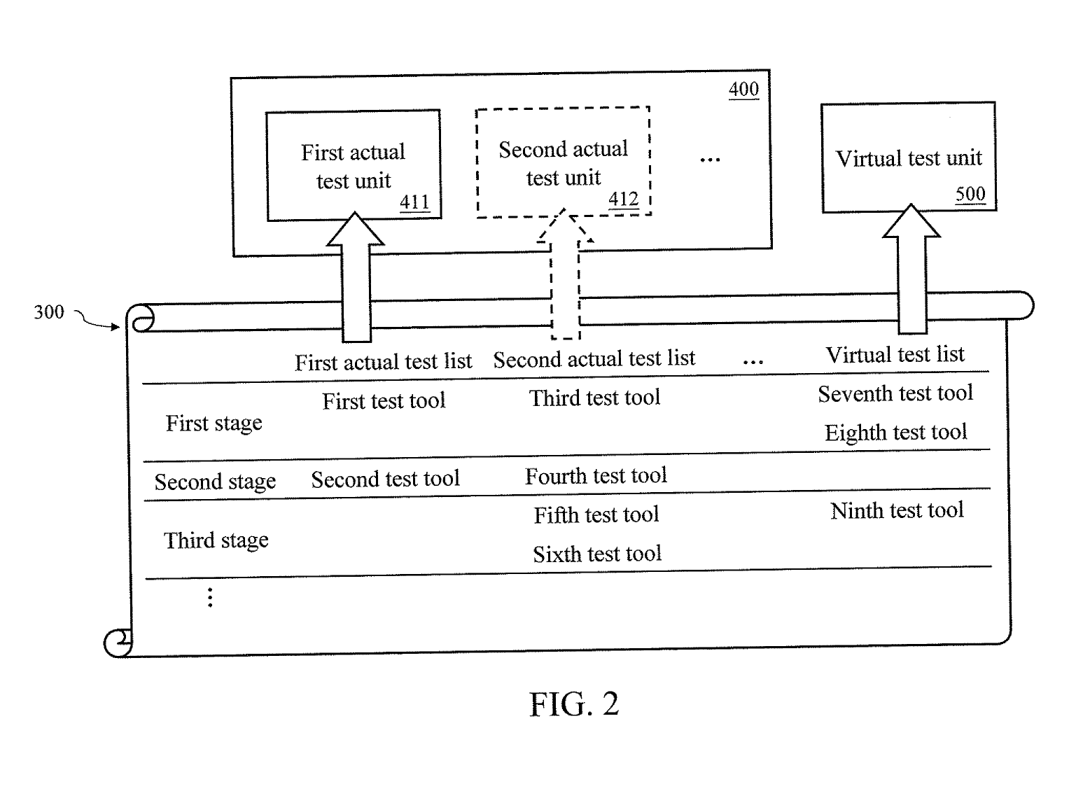

Different from the test script in the prior art, the test script acquired by the script acquisition module 120 further includes a virtual test list corresponding to the virtual test unit generated by the test unit generation module 110 in addition to an actual test list corresponding to the actual test unit in the device 400 to be tested. As shown in FIG. 2, the test script 300 at least includes a first actual test list and a virtual test list. The script acquisition module 120 may transmit, through the transmission module 140, the first actual test list to a first actual test unit 411 of the device 400 to be tested, so that the first actual test unit 411 of the device 400 to be tested performs the test according to the first actual test list, while the virtual test list is provided by the script acquisition module 120 to the virtual test unit 500.

It should be noted that, the structure and content of the virtual test list is similar to those of the actual test list; therefore, for the test script, the virtual test list is the same as the actual test list, and both are used to define the test items and are test tools used during the test. That is to say, in establishing the test script, it is merely required to add the content of the virtual test list and it is not required to re-schedule the structure of the test script and perform other additional processing procedures.

The test module 130 is used to execute, in the virtual test unit generated by the test unit generation module 110, test tools corresponding to the virtual test lists corresponding to the virtual test unit, so as to integrally test the device 400 to be tested, and obtain a test result produced after the device 400 to be tested is tested by using the test tools.

The test result obtained by the test module 130 includes a total current and a total voltage required when all entities in the device 400 to be tested are turned on at the same time, and/or a network state when the device 400 to be tested operates, but the present invention is not limited thereto, and data generated when the test can be performed merely outside the device 400 to be tested can all be used as the tests result mentioned in the present invention.

In addition, since test stages or a test sequence of the test item are probably defined in the virtual test list, the test module 130 may sequentially execute, according to the test stages and/or the test sequence of each test item defined in the test script, test tools corresponding to each test item in the virtual test list.

The transmission module 140 is used to, when the device 400 to be tested is connected to the device for executing the present invention, transmit, through the connection interface 101, the test script acquired by the script acquisition module 120 to the device 400 to be tested, so that the actual test units in the device 400 to be tested respectively execute test tools corresponding to the actual test list corresponding to each actual test unit in the test script, so as to test the actual test units.

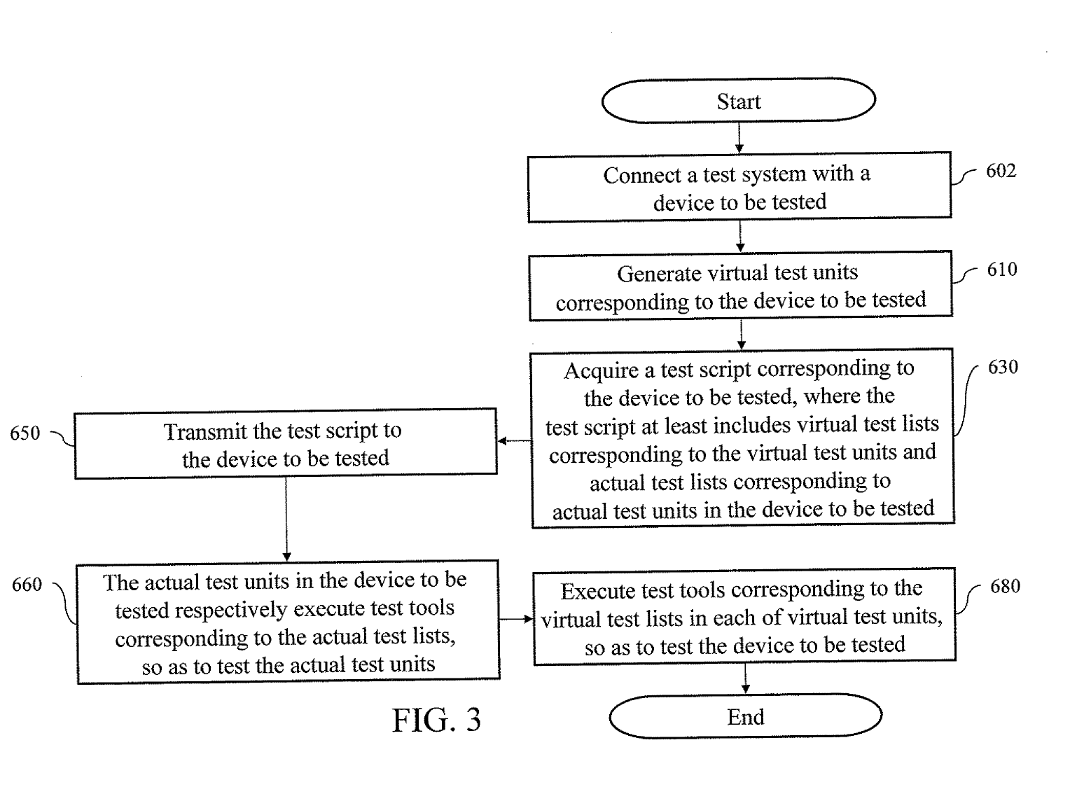

Then, with reference to an embodiment, an operating system and a method in the present invention are illustrated. Referring to FIG. 3, a flow chart of a test method by generating a virtual test unit outside a device to be tested according to the present invention is shown. In this embodiment, it is supposed that the device 400 to be tested is a rack including two servers, where each actual test unit in the device 400 to be tested one-to-one corresponding to each server in the rack. That is to say, the device 400 to be tested includes two actual test units.

First, a user may connect the device 400 to be tested and the test apparatus 100 for executing the present invention (step 602). After the device 400 to be tested is connected, through the connection interface 101, to the test apparatus 100 for executing the present invention, the test unit generation module 110 may generate a virtual test unit corresponding to the device 400 to be tested (step 610).

Likewise, After the device 400 to be tested is connected, through the connection interface 101, to the test apparatus 100 for executing the present invention, the script acquisition module 120 may acquire a test script corresponding to the device 400 to be tested (step 630).

The execution sequence of the step of the script acquisition module 120 acquiring the test script corresponding to the device 400 to be tested (step 630) and the step of the test unit generation module 110 generating the virtual test unit 500 corresponding to the device 400 to be tested (step 610) is not limited, that is, the test unit generation module 100 may also generate the virtual test unit 500 corresponding to the device 400 to be tested after the script acquisition module 120 acquires the test script corresponding to the device 400 to be tested (step 610).

After the script acquisition module 120 acquires the test script corresponding to the device 400 to be tested (step 630), the following step is the same as that in the prior art. The transmission module 140 may transmit, through the connection interface 101, the acquired test script to each server of the device 400 to be tested (step 650), so that the actual test units in the servers of the device 400 to be tested respectively execute test tools corresponding to an actual test list corresponding to an actual test unit, so as to test the entities in the device 400 to be tested (step 660). In this embodiment, as shown in FIG. 2, in the device 400 to be tested, the first actual test unit 411 executes the test tools in a first actual test list corresponding to the test script 300, and a second actual test unit 412 executes the test tools in a second actual test list corresponding to the test script.

In addition, after the test unit generation module 110 generates the virtual test units corresponding to the device 400 to be tested (step 610), the test module 130 may execute, in the virtual test units 500 generated by the test unit generation module 110, test tools scheduled in the virtual test lists corresponding to the test script 300, so as to integrally test the device 400 to be tested (step 680), and obtain a test result produced after the device 400 to be tested is tested by using the test tools.

In the foregoing embodiment, in the test script 300, different test stages are used to schedule the test tools capable of being synchronously executed and further schedule a sequence of executing the test tools. That is to say, the virtual test unit 500 may synchronously execute the seventh test tool and the eighth test tool; meanwhile, the first actual test unit 411/the second actual test unit 412 may also execute the first test tool/the third test tool. However, if a test in a second stage needs to be performed on the virtual test unit 500/the first actual test unit 411/the second actual test unit 412, the execution of the seventh test tool, the eighth test tool, the first test tool, and the third test tool needs to be finished. Similarly, if a test in a third stage needs to be performed on the virtual test unit 500/the first actual test unit 411/the second actual test unit 412, since the virtual test unit 500 does not execute any test tool in the second stage, the virtual test unit 500/the first actual test unit 411/the second actual test unit 412 needs to wait for the execution completion of the second test tool and the fourth test tool.

To sum up, it can known that, the difference between the present invention and the prior art lies in that, in the present invention, the virtual test unit is generated outside the device to be tested, and the virtual test unit executes the test tools according to the test script, so as to test the device to be tested. Through such a technical means, the problem in the prior art the existing test model cannot test the overall performance of the device to be tested and including multiple entities, thereby achieving the technical efficacy of expanding the application scope of the existing test model.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A test method by generating a virtual test unit outside a device to be tested, applied to a test apparatus, and at least comprising the following steps:
connecting the test apparatus with a device to be tested;
generating at least one virtual test unit corresponding to the device to be tested;
acquiring a test script corresponding to the device to be tested, wherein the test script at least comprises virtual test lists corresponding to the virtual test units; and
executing test tools corresponding to the virtual test lists in each of the virtual test units, so as to test the device to be tested.

2. The test method by generating a virtual test unit outside a device to be tested according to claim 1, wherein after the acquiring the test script corresponding to the device to be tested, further comprising: transmitting the test script to the device to be tested, so that each actual test unit in the device to be tested executes test tools corresponding to actual test lists in the test script, so as to test the actual test units.

3. The test method by generating a virtual test unit outside a device to be tested according to claim 1, wherein the step of executing the test tools corresponding to the virtual test lists in each of the virtual test units comprises: obtaining a test result produced after the device to be tested is tested with the test tools.

4. The test method by generating a virtual test unit outside a device to be tested according to claim 1, wherein the step of executing the test tools corresponding to the virtual test lists in each of the virtual test units is sequentially executing the test tools corresponding to the virtual test lists according to test stages and/or a test sequence defined in the test script.

5. A test system by generating a virtual test unit outside a device to be tested, wherein a connection for the device to be tested is provided and the test system at least comprises:
a test unit generation module, used to generate at least one virtual test unit corresponding to the device to be tested;
a script acquisition module, used to acquire a test script corresponding to the device to be tested, wherein the test script at least comprises virtual test lists corresponding to the virtual test units; and
a test module, used to execute, in the virtual test units, test tools corresponding to the virtual test lists, so as to test the device to be tested.

6. The test system by generating a virtual test unit outside a device to be tested according to claim 5, wherein the test system further comprises a transmission module, used to transmit the test script to the device to be tested, so that each actual test unit in the device to be tested executes test tools corresponding to actual test units in the test script, so as to test the actual test units.

7. The test system by generating a virtual test unit outside a device to be tested according to claim 5, wherein the test module sequentially executes test tools corresponding to the virtual test lists according to test stages and/or a test sequence defined in the test script.

8. The test system by generating a virtual test unit outside a device to be tested according to claim 5, wherein the test module is further used to obtain a test result produced after the device to be tested is tested with the test tools.

9. The test system by generating a virtual test unit outside a device to be tested according to claim 5, wherein the device to be tested is a stand-alone device or a rack comprising multiple servers.
